(19) United States
(12) Patent Application Publication
(10) Pub. No.: US 2019/0284990 A1
(43) Pub. Date: Sep. 19, 2019

(54) TURBOCHARGER

(71) Applicant: TOYOTA JIDOSHA KABUSHIKI KAISHA, Toyota-shi (JP)

(72) Inventor: Yusuke AOYAGI, Toyota-shi (JP)

(73) Assignee: TOYOTA JIDOSHA KABUSHIKI KAISHA, Toyota-shi (JP)

(21) Appl. No.: 16/281,263

(22) Filed: Feb. 21, 2019

(30) Foreign Application Priority Data
Mar. 16, 2018 (JP) 2018-049320

(51) Int. Cl. F02B 37/18; F01D 17/10

(52) U.S. Cl. CPC F02B 37/183; F05B 2220/40; F01D 17/105

(57) ABSTRACT

A turbocharger includes a turbine wheel, a turbine housing including a through-hole, a waste gate valve including a shaft, and a bushing slidably supporting the shaft. The through-hole includes a first end, a second end, and a circular conical surface in a region that includes the first end. The circular conical surface has a diameter that is increased in a direction extending from the second end toward the first end. The bushing includes an abutment portion that abuts against an entire circumference of the circular conical surface. At least one of an outer circumferential surface of the shaft or an inner circumferential surface of the bushing includes a recess. The recess is located in a range at least partially corresponding to a range in the axial direction of the through-hole where the circular conical surface abuts against the abutment portion.

### BACKGROUND

The present disclosure relates to a turbocharger.

Japanese Laid-Open Patent Publication No. 2015-163782 discloses a turbocharger including a turbine housing that accommodates a turbine wheel. The turbine housing includes a bypass passage that connects an exhaust upstream side to an exhaust downstream side of the turbine wheel in order to bypass the turbine wheel. Further, the turbine housing includes a waste gate valve that opens and closes the bypass passage.

A wall of the turbine housing includes a through-hole through which the shaft of the waste gate valve is inserted. A tubular bushing is press-fitted into the through-hole. The bushing rotationally supports the shaft of the waste gate valve. When the shaft is rotated, the outer circumferential surface of the shaft slides on the inner circumferential surface of the bushing.

In the turbocharger of the above publication, exhaust gas circulating inside the turbine housing may leak out of the turbine housing through a gap between the inner circumferential surface of the through-hole and the outer circumferential surface of the bushing. If the portion of the bushing press-fitted into the through-hole is increased, the amount of contact will be increased between the inner circumferential surface of the through-hole and the outer circumferential surface of the bushing. However, such a structure may deform the bushing inward in the radial direction and thereby increase the sliding resistance of the shaft against the bushing. If the sliding resistance of the shaft against the bushing is excessively increased, the waste gate valve will not be smoothly rotated relative to the bushing.

### SUMMARY

A turbocharger to solve the above problem includes a turbine wheel; a turbine housing accommodating the turbine wheel, wherein the turbine housing includes a wall that has a through-hole and a bypass passage that connects an exhaust upstream side to an exhaust downstream side of the turbine wheel; a waste gate valve attached to the turbine housing and configured to open and close the bypass passage, wherein the waste gate valve includes a shaft; and a bushing press-fitted into the through-hole of the turbine housing and slidably supporting the shaft. The through-hole includes a first end and a second end in the axial direction of the through-hole, the through-hole includes a circular conical surface in a region that includes the first end, and the circular conical surface has a diameter that is increased in a direction extending from the second end toward the first end. The bushing includes an abutment portion that abuts against the entire circumference of the circular conical surface. At least one of an outer circumferential surface of the shaft or an inner circumferential surface of the bushing includes a recess recessed in a radial direction of the through-hole. The recess is located in a range at least partially corresponding to a range in the axial direction of the through-hole where the circular conical surface abuts against the abutment portion.

Other aspects and advantages of the embodiments will become apparent from the following description, taken in conjunction with the accompanying drawings, illustrating by way of example the principles of the invention.

### BRIEF DESCRIPTION OF THE DRAWINGS

The embodiments, together with objects and advantages thereof, may best be understood by reference to the following description of the presently preferred embodiments together with the accompanying drawings in which:

FIG. 1 is a schematic view of an internal combustion engine including a turbocharger according to one embodiment;

FIG. 2 is a schematic view of the turbocharger according to the embodiment; and

FIG. 3 is a cross-sectional view showing a part of the turbocharger in FIG. 2.

### DETAILED DESCRIPTION

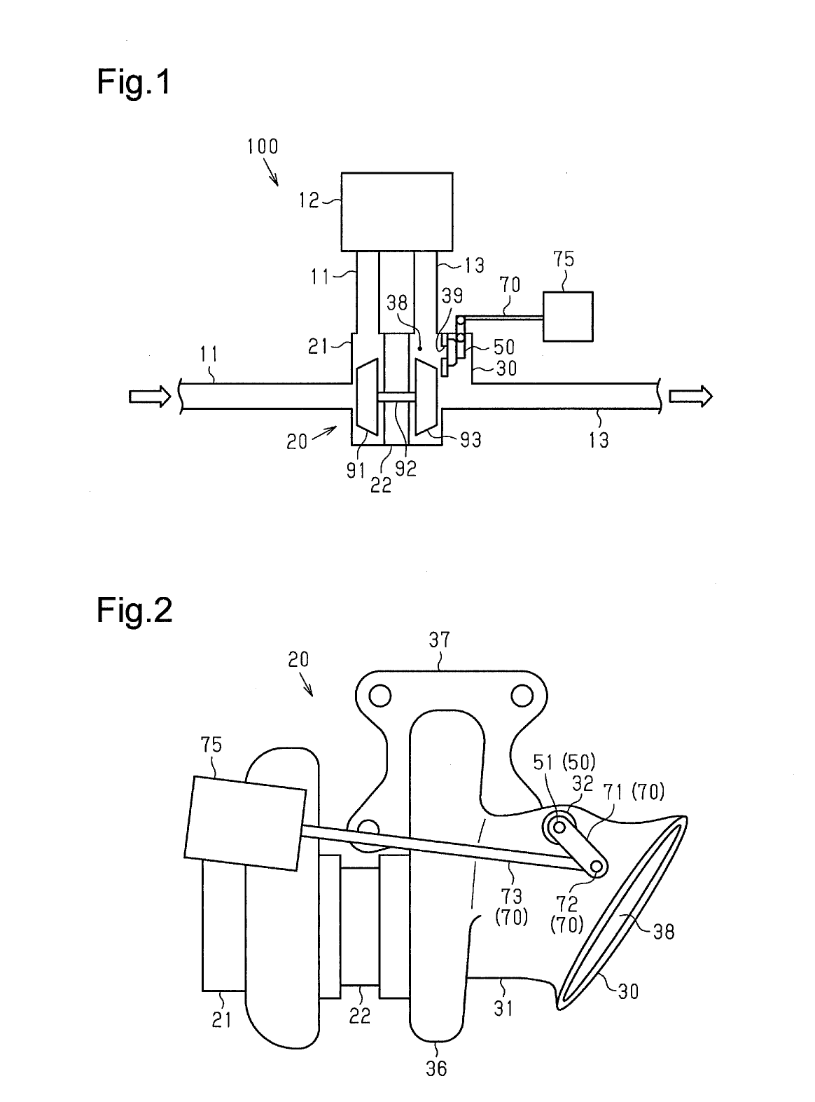

One embodiment of the present invention will now be described with reference to FIGS. 1 to 3. The structure of an internal combustion engine 100 of a vehicle to which the present invention is applied will first be described.

As shown in FIG. 1, the internal combustion engine 100 includes an intake passage 11 through which intake air is drawn from the outside of the internal combustion engine 100. The intake passage 11 is connected to a cylinder 12 in which fuel is mixed with the intake air and burned. The cylinder 12 is connected to an exhaust passage 13 into which exhaust gas is discharged from the cylinder 12.

The internal combustion engine 100 includes a turbocharger 20 that uses the flow of exhaust gas to compress the intake air. The turbocharger 20 includes a compressor housing 21, a bearing housing 22, a turbine housing 30, and a waste gate valve 50 coupled to the turbine housing 30. The compressor housing 21 is coupled to the intake passage 11. The turbine housing 30 is coupled to the exhaust passage 13. The compressor housing 21 and the turbine housing 30 are connected by the bearing housing 22.

As shown in FIG. 2, the turbine housing 30 includes a circumferential wall 31, which is annular in its entirety, an arcuate portion 36, which is continuous with the circumferential wall 31, and a flange 37. A main passage 38 is defined inside the circumferential wall 31 and the arcuate portion 36. The arcuate portion 36 extends around the outer surface of the circumferential wall 31. The flange 37 extends outward in the radial direction from an exhaust upstream end of the arcuate portion 36. The flange 37 is connected to an exhaust upstream side of the turbine housing 30 in the exhaust passage 13. Exhaust gas is drawn into the space inside the circumferential wall 31 through the arcuate portion 36 to flow through the main passage 38.

As shown in FIG. 1, the main passage 38 accommodates a turbine wheel 93. The turbine housing 30 includes a bypass passage 39 defined inside the circumferential wall 31 and the arcuate portion 36. The bypass passage 39 connects an upstream side of the turbine wheel 93 to a downstream side of the turbine wheel 93 in the main passage 38. In other words, exhaust gas flows through the bypass passage 39 to bypass the turbine wheel 93.

The turbine wheel 93 is connected to a first end of a connecting shaft 92. A central portion of the connecting shaft 92 in the axial direction is accommodated in the bearing housing 22. The connecting shaft 92 is rotationally supported by a bearing (not shown) inside the bearing housing 22. A second end of the connecting shaft 92 is connected to a compressor wheel 91. The compressor wheel 91 is accommodated in the compressor housing 21.

Exhaust gas flowing through the main passage 38 strikes and rotates the turbine wheel 93. Rotation of the turbine wheel 93 rotates the compressor wheel 91 with the connecting shaft 92 and compresses the intake air.

Referring to FIG. 1, the waste gate valve 50 is configured to open and close the bypass passage 39. The waste gate valve 50 is connected to an output shaft of an actuator 75 by a connecting member 70.

The periphery of the waste gate valve 50 will now be described in detail.

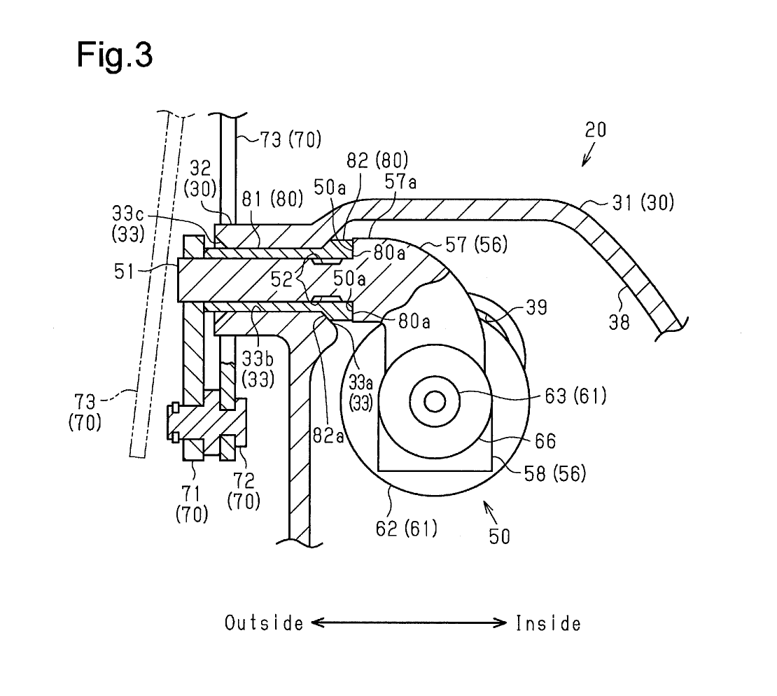

As shown in FIG. 2, a substantially cylindrical projection 32 projects outward from a part of the circumferential wall 31, which serves as a wall of the turbine housing 30. As shown in FIG. 3, the circumferential wall 31 and the projection 32 include a through-hole 33 having a substantially circular cross section. The through-hole 33 extends along the central axis of the projection 32. The through-hole 33 connects the inside of the turbine housing 30 to the outside of the turbine housing 30.

As shown in FIG. 3, the through-hole 33 includes an inner circular conical surface 33a, a press-fit circumferential surface 33b, and an outer circular conical surface 33c arranged in order from the inside of the turbine housing 30 to the outside of the turbine housing 30 in the axial direction of the through-hole 33 (right-left direction in FIG. 3). The inner circular conical surface 33a has a diameter that is increased toward the inside of the turbine housing 30 in the axial direction. The press-fit circumferential surface 33b has a diameter that is substantially the same in the axial direction of the through-hole 33. The outer circular conical surface 33c has a diameter that is increased toward the outside of the turbine housing 30 in the axial direction of the through-hole 33.

The turbocharger 20 also includes a tubular bushing 80. The bushing 80 includes a press-fit portion 81 that has the same diameter in the axial direction and an abutment portion 82 that has a greater diameter than the press-fit portion 81. The press-fit portion 81 and the abutment portion 82 are arranged in the axial direction, and the abutment portion 82 is located at a first end in the axial direction. The abutment portion 82 of the bushing 80 is located inside the turbine housing 30.

The press-fit portion 81 of the bushing 80 is press-fitted into the press-fit circumferential surface 33b of the through-hole 33. The outer diameter of the press-fit portion 81 is slightly greater than the diameter of the press-fit circumferential surface 33b before being press-fitted into the press-fit circumferential surface 33b. The outer diameter of the press-fit portion 81 becomes substantially the same as the diameter of the press-fit circumferential surface 33b when press-fitted into the press-fit circumferential surface 33b. The outer circumferential surface of the press-fit portion 81 is in planar contact with the press-fit circumferential surface 33b. The press-fit portion 81 is longer in the axial direction than the press-fit circumferential surface 33b. The abutment portion 82 of the bushing 80 is located inward in the turbine housing 30 from the press-fit circumferential surface 33b of the through-hole 33.

The abutment portion 82 includes an abutment surface 82a, which is a circular conical surface that extends from the press-fit portion 81 toward the inside of the turbine housing 30 to increase the diameter of the circular conical surface, and an end surface 80a in the axial direction of the bushing 80. The inclination angle of the abutment surface 82a relative to the central axis of the bushing 80 is substantially the same as the inclination angle of the inner circular conical surface 33a relative to the central axis of the through-hole 33. The abutment surface 82a is entirely in planar contact with the inner circular conical surface 33a.

As shown in FIG. 3, the waste gate valve 50 includes a shaft 51, which is cylindrical in its entirety, and an arm 56. The axis of the shaft 51 corresponds to the central axes of the through-hole 33 and the bushing 80. The radial direction of the shaft 51 corresponds to the radial directions of the through-hole 33 and the bushing 80. The outer diameter of the shaft 51 is substantially the same as the inner diameter of the bushing 80. The shaft 51 is arranged inside the bushing 80 such that the outer circumferential surface of the shaft 51 is slidable on the inner circumferential surface of the bushing 80. The bushing 80 slidably supports the shaft 51. The shaft 51 includes an inner end (right end in FIG. 3) arranged inside the turbine housing 30 and an outer end (left end in FIG. 3) arranged outside the turbine housing 30.

The arm 56 includes a curved portion 57, which extends and is curved from the inner end of the shaft 51, and a fixed portion 58, which has the form of a substantially quadrangular plate. The curved portion 57 includes an end portion 57a connected to the shaft 51 and a portion extending from the end portion 57a and curved to be arcuate. The end portion 57a of the curved portion 57 has a circular cross section of which the center corresponds to the axis of the shaft 51. In other words, the axis of the end portion 57a corresponds to the axis of the shaft 51. The diameter of the end portion 57a is greater than the diameter of the shaft 51. The boundary between the shaft 51 and the end portion 57a includes a step surface 50a extending over the entire circumference of the shaft 51. The step surface 50a faces the end surface 80a of the bushing 80 and is in planar contact with the end surface 80a.

The fixed portion 58 extends from an end (lower end in FIG. 3) of the curved portion 57 at the opposite side of the shaft 51. The fixed portion 58 includes a fixing hole (not shown) that extends through the fixed portion 58 from a first surface (surface that is not shown in FIG. 3) to a second surface of the fixed portion 58. A valve body 61 that opens and closes the bypass passage 39 is attached to the fixed portion 58. The valve body 61 includes a substantially cylindrical valve shaft 63. A central portion of the valve shaft 63 in the axial direction is arranged inside the fixing hole of the fixed portion 58. A first end (end that is not shown in FIG. 3) of the valve shaft 63 projects out of the fixed portion 58 from the fixing hole. A valve plate 62, which is substantially disk-shaped, extends from the first end of the valve shaft 63. The diameter of the valve plate 62 is greater than the diameter of the valve shaft 63. A second end (end that is shown in FIG. 3) of the valve shaft 63 projects out of the fixed portion 58 from the fixing hole. A support plate 66, which is substantially disk-shaped, is fixed to the second end of the valve shaft 63.

As shown in FIG. 3, the turbocharger 20 further includes the connecting member 70. The connecting member 70 includes a link arm 71, which substantially has the form of a plate, a connecting pin 72, and a rod 73, which is rod-shaped in its entirety. The link arm 71 includes a first end secured to the outer end (left end in FIG. 3) of the shaft 51 and a second end located at the opposite side of the first end. The second end of the link arm 71 is connected to the rod 73 by the connecting pin 72. The rod 73 includes a first end connected to the second end of the link arm 71 and a second end connected to an output shaft of the actuator 75 as shown in FIG. 2. The actuator 75 is fixed to the compressor housing 21.

As shown by the double-dashed lines in FIG. 3, before the first end of the rod 73 is connected to the second end of the link arm 71, the first end of the rod 73 connected to the output shaft of the actuator 75 is located farther (further leftward in FIG. 3) from the turbine housing 30 than the outer end of the shaft 51. Thus, in a state in which the first end of the rod 73 is connected to the second end of the link arm 71, the rod 73 is elastically deformed toward the inside of the turbine housing 30 (rightward in FIG. 3) in the axial direction. The rod 73 biases the shaft 51 of the waste gate valve 50 accordingly with the link arm 71 from the inside of the turbine housing 30 toward the outside in the axial direction of the through-hole 33. In other words, in the present embodiment, the rod 73 is a biasing member that biases the shaft 51. FIG. 3 exaggeratedly illustrates the location of the first end of the rod 73 outside the turbine housing 30 before the first end of the rod 73 is connected to the second end of the link arm 71.

When the actuator 75 drives and rotates the shaft 51 of the waste gate valve 50 around its axis in a first direction, the valve plate 62 of the waste gate valve 50 covers the bypass passage 39. This closes the bypass passage 39. When the actuator 75 drives and rotates the shaft 51 of the waste gate valve 50 around its axis in a second direction, the valve plate 62 of the waste gate valve 50 moves away from the bypass passage 39. This opens the bypass passage 39.

As shown in FIG. 3, the shaft 51 of the waste gate valve 50 includes a recess 52 in the outer circumferential surface. The recess 52 is recessed inward in the radial direction of the through-hole 33. The recess 52 extends over the entire circumference of the shaft 51. In the axial direction of the through-hole 33, a range where the recess 52 is located at least partially corresponds to where the abutment surface 82a abuts against the inner circular conical surface 33a. The recess 52 is longer in the axial direction than the location where the abutment surface 82a of the bushing 80 abuts against the inner circular conical surface 33a of the through-hole 33. That is, in the present embodiment, the range where the recess 52 is located includes the entire range in the axial direction of the through-hole 33 where the abutment surface 82a and the inner circular conical surface 33a abut against each other.

The operation and advantages of the present embodiment will now be described.

As shown in FIG. 3, the bushing 80 is press-fitted into the through-hole 33 of the turbine housing 30. If the bushing 80 does not include the abutment portion 82, the outer circumferential surface of the press-fit portion 81 will be in planar contact with only the press-fit circumferential surface 33b of the through-hole 33. In such a case, the exhaust gas flowing inside the turbine housing 30 may leak out of the turbine housing 30 through a gap between the press-fit circumferential surface 33b and the outer circumferential surface of the press-fit portion 81.

In the present embodiment, the abutment surface 82a of the bushing 80 entirely abuts against the inner circular conical surface 33a of the through-hole 33. Thus, in the present embodiment, in addition to the abutment between the press-fit circumferential surface 33b and the press-fit portion 81, the abutment surface 82a of the bushing 80 is in abutment with the inner circular conical surface 33a of the through-hole 33. This limits exhaust gas leakage from the turbine housing 30.

Force acting to abut the abutment surface 82a of the bushing 80 against the inner circular conical surface 33a of the through-hole 33 deforms the portion of the bushing 80 that abuts against the inner circular conical surface 33a inward in the radial direction. If the shaft 51 of the waste gate valve 50 were not to include the recess 52, deformation of the bushing 80 would result in the inner circumferential surface of the bushing 80 being strongly pressed against the outer circumferential surface of the shaft 51 and thereby excessively increase the sliding resistance of the shaft 51 against the bushing 80.

In contrast, the present embodiment includes the recess 52 at an inner side in the radial direction of the through-hole 33 of where the abutment surface 82a abuts against the press-fit circumferential surface 33b. Thus, even if the bushing 80 is deformed, the recess 52 of the shaft 51 will absorb (reduce) the deformation of the bushing 80. This avoids situations in which deformation of the bushing 80 would result in the inner circumferential surface of the bushing 80 being strongly pressed against the outer circumferential surface of the shaft 51. Thus, the sliding resistance will not be excessively increased between the inner circumferential surface of the bushing 80 and the outer circumferential surface of the shaft 51.

Further, in the present embodiment, the recess 52 extends over the entire circumference of the shaft 51. Thus, abutment of the inner circumferential surface of the bushing 80 against the outer circumferential surface of the shaft 51 is limited over the entire circumference of the shaft 51 in the region where the recess 52 is located. This allows the present embodiment to further reduce the sliding resistance of the shaft 51 against the bushing 80 as compared with a structure in which the recess 52 is arranged in part of the shaft 51 in the circumferential direction of the shaft 51.

If the outer diameter of the shaft 51 were to be smaller than the inner diameter of the bushing 80 due to manufacturing dimensional errors, the exhaust gas flowing inside the turbine housing 30 may leak out of the turbine housing 30 through a gap between the bushing 80 and the shaft 51.

In the present embodiment, the step surface 50a of the waste gate valve 50 is in planar contact with the end surface 80a of the bushing 80. Thus, the present embodiment limits the flow of exhaust gas between the bushing 80 and the shaft 51 through a gap between the step surface 50a (end portion 57a of arm 56) and the end surface 80a. Consequently, the abutment between the step surface 50a and the end surface 80a in addition to the abutment between the inner circumferential surface of the bushing 80 and the outer circumferential surface of the shaft 51 prevents exhaust gas from flowing out of the turbine housing 30.

Further, in the present embodiment, the rod 73 biases the shaft 51 of the waste gate valve 50 in the axial direction of the through-hole 33 from the inside of the turbine housing 30 toward the outside. Thus, in the present embodiment, in contrast to a structure in which the shaft 51 is not biased, the step surface 50a is pressed against the end surface 80a so as to limit the formation of a gap between the step surface 50a and the end surface 80a. This prevents exhaust gas leakage from the turbine housing 30 through a gap between the inner circumferential surface of the bushing 80 and the outer circumferential surface of the shaft 51 even if, for example, the shaft 51 vibrates when rotated.

If exhaust gas flows inside the turbine housing 30, the pressure inside the turbine housing 30 will be greater than pressure outside of the turbine housing 30. Thus, force directed from the inside toward the outside of the turbine housing 30 acts on the waste gate valve 50 in the axial direction of the through-hole 33. As a result, the step surface 50a of the waste gate valve 50 is pressed against the end surface 80a of the bushing 80 from the inside toward the outside of the turbine housing 30 in the axial direction of the through-hole 33. Thus, the inner circular conical surface 33a of the through-hole 33 is pressed further strongly against the abutment surface 82a of the bushing 80. The pressure difference between the inside and the outside of the turbine housing 30 limits the formation of a gap between the end surface 80a and the step surface 50a (end portion 57a of the arm 56) and a gap between the inner circular conical surface 33a and the abutment surface 82a.

The present embodiment may be modified and implemented as follows. The present embodiment and the following modifications may be implemented in combination as long as there are no technical contradictions.

The range where the recess 52 is located in the axial direction of the through-hole 33 may correspond to only a part of a range where the abutment surface 82a of the bushing 80 abuts against the inner circular conical surface 33a of the through-hole 33. In other words, the range where the recess 52 is located in the axial direction of the through-hole 33 may at least partially correspond to the range where the abutment surface 82a abuts against the inner circular conical surface 33a.

In the above embodiment, the length of the recess 52 in the axial direction of the through-hole 33 may be changed. For example, the recess 52 may be shorter in the axial direction than where the abutment surface 82a abuts against the inner circular conical surface 33a.

In the above embodiment, the recess 52 may be arranged in part of the shaft 51 in the circumferential direction of the shaft 51. At least the portion where the recess 52 is arranged will absorb (reduce) radially inward deformation of the bushing 80. Thus, sliding resistance can be reduced.

In the above embodiment, the recess 52 of the shaft 51 may be replaced with or additionally include a recess that is formed in the inner circumferential surface of the bushing 80 and recessed outward in the redial direction. In this case, a range where the recess of the bushing 80 is located in the axial direction of the through-hole 33 may at least partially correspond to a range where the abutment surface 82a abuts against the inner circular conical surface 33a.

In the above embodiment, the shape of the end portion 57a of the arm 56 may be changed. The cross section of the end portion 57a orthogonal to the axis may be, for example, elliptic or substantially quadrangular as long as the step surface 50a is arranged over the entire circumference.

The step surface 50a may be partially or completely omitted in the circumferential direction if it is unlikely that exhaust gas would leak out of the turbine housing 30 through a gap between the inner circumferential surface of the bushing 80 and the outer circumferential surface of the shaft 51.

In the above embodiment, the structure of the biasing member may be changed. For example, a disc spring serving as the biasing member may be arranged between the projection 32 and link arm 71 in the axial direction of the through-hole 33. The disc spring may bias the shaft 51 outward from the turbine housing 30 in the axial direction of the through-hole 33. In this case, the rod 73 does not need to bias the shaft 51.

Further, the biasing member that biases the shaft 51 may be omitted if it is unlikely that a gap would be formed between the step surface 50a (end portion 57a of the arm 56) and the end surface 80a of the bushing 80 even if, for example, the shaft 51 vibrates when rotated.

In the embodiment, the abutment portion 82 of the bushing 80 may be located at an outer side of the turbine housing 30 in the axial direction of the through-hole 33. For example, the abutment portion 82 of the bushing 80 may abut against the outer circular conical surface 33c of the through hole 33 as long as exhaust gas leakage from the turbine housing 30 can be sufficiently prevented without using the pressure difference between the inside and the outside of the turbine housing 30. In other words, the abutment portion 82 of the bushing 80 may be arranged outside the turbine housing 30. In this case, the abutment portion 82 of the bushing 80 abuts against the entire outer circular conical surface 33c. In this case, the location of the recess 52 may be changed in accordance with where the abutment portion 82 abuts against the outer circular conical surface 33c.

In the above embodiment, the shape of the abutment portion 82 of the bushing 80 may be changed. For example, the inclination angle of the abutment surface 82a relative to the central axis of the bushing 80 may be greater than the inclination angle of the inner circular conical surface 33a relative to the central axis of the through-hole 33. In this case, a part of the abutment surface 82a of the bushing 80 may at least be in linear contact with the inner circular conical surface 33a around the entire circumference.

The present examples and embodiments are to be considered as illustrative and not restrictive, and the invention is not to be limited to the details given herein, but may be modified within the scope and equivalence of the appended claims.

1. A turbocharger comprising:
a turbine wheel;
a turbine housing accommodating the turbine wheel, wherein the turbine housing includes a wall that has a through-hole and a bypass passage that connects an exhaust upstream side to an exhaust downstream side of the turbine wheel;
a waste gate valve attached to the turbine housing and configured to open and close the bypass passage, wherein the waste gate valve includes a shaft; and
a bushing press-fitted into the through-hole of the turbine housing and slidably supporting the shaft, wherein
the through-hole includes a first end and a second end in an axial direction of the through-hole, the through-hole includes a circular conical surface in a region that includes the first end, and the circular conical surface has a diameter that is increased in a direction extending from the second end toward the first end,
the bushing includes an abutment portion that abuts against an entire circumference of the circular conical surface,
at least one of an outer circumferential surface of the shaft or an inner circumferential surface of the bushing includes a recess recessed in a radial direction of the through-hole, and
the recess is located in a range at least partially corresponding to a range in the axial direction of the through-hole where the circular conical surface abuts against the abutment portion.

2. The turbocharger according to claim 1, wherein the recess extends over an entire circumference of the shaft or the bushing.

3. The turbocharger according to claim 1, wherein:
the shaft includes an inner end arranged inside the turbine housing;
the waste gate valve further includes an arm extending from the inner end of the shaft, a step surface extending over an entire circumference at a boundary between the shaft and the arm and facing the bushing, and a valve body attached to the arm and configured to open and close the bypass passage; and
the step surface is in planar contact with an end surface of the bushing.

4. The turbocharger according to claim 3, further comprising:
a biasing member that biases the shaft outward from an inside of the turbine housing in the axial direction of the through-hole.

5. The turbocharger according to claim 3, wherein the first end of the through-hole is located inside the turbine housing.
